(19) United States
(12) Patent Application Publication
(10) Pub. No.: US 2009/0170973 A1
(43) Pub. Date: Jul. 2, 2009

(54) Macroporous hydrogels, their preparation and their use

(76) Inventors: Bo Mattiasson, Hjärup (SE); Igor Galaev, Lund (SE); Irina Savina, Brighton (GB)

Correspondence Address: MCDERMOTT WILL & EMERY LLP, 600 13TH STREET, N.W., WASHINGTON, DC, 20005-3096, US

(21) Appl. No.: 11/920,255

(22) PCT Filed: May 11, 2006
(86) PCT No.: PCT/SE2006/000555

§ 371 Date: Mar. 4, 2009

(30) Foreign Application Priority Data
May 13, 2005 (SE) 0501087-1

(51) Int. Cl. C08F 265/10; C08F 265/02; C08F 261/04

(52) U.S. Cl. 521/134

(57) ABSTRACT

A macroporous cryogen is disclosed which has grafted thereon polymer chains formed by polymerizing at least one monomer of the general formula (I) CR1R2=CR3R4 (I) wherein R1 and R2 are equal of different and each represents a hydrogen atom or substituent group which is not detrimental to the polymerization reaction; and R3 and R4 each represents a hydrogen atom or a substituent group which is not detrimental to the polymerization reaction, provided that R3 and R4 are not both a hydrogen atom, on said macroporous cryogel. A method for the preparation of said macroporous cryogel by graft (co)polymerization and the use of said macroporous cryogel in a separation process are also disclosed.

### TECHNICAL FIELD

The present invention relates to macroporous hydrogels, to processes for their preparation and to the use of such macroporous cryogels. More particularly, the present invention relates to macroporous hydrogels having polymer chains grafted on the surface thereof and to processes for the preparation of such macroporous hydrogels and the use of such macroporous hydrogels in separation processes.

### BACKGROUND ART

Hydrogels are formed by physically or chemically cross-linked three-dimensional polymer network capable of holding a large amount of water while at the same time maintaining their shape. A low interface tension and hydrophilic properties make hydrogels highly biocompatible allowing their numerous applications in biotechnology and biomedicine including their use as chromatographic materials, carriers for immobilisation of molecules and cells, matrices for electrophoresis and immunodiffusion, scaffolds for cultivation of microbial and mammalian cells, implants and drug delivery systems. The increasing demands in hydrogel for different applications require access to new types of hydrogels with improved properties. Grafting polymer chains onto the backbone of polymer materials has been pointed out as a convenient method for improving properties of polymer materials.

Hydrogels with terminally bound polymer chains (grafted hydrogels) may be prepared by several methods. Grafted hydrogels were formed when the polymerization mixture contained macromonomer or as the result of cross-linking of preformed soluble graft copolymers. New thermo- and pH-sensitive hydrogels were obtained in this way. However, this approach demands the preparation of macromonomers or graft copolymers which is time consuming and sometimes rather complicated. Moreover, it is difficult to control the localization and density of grafted polymer chains in such grafted hydrogels.

Alternatively, grafting polymers to the gel surface could be achieved via chemical bonding between reactive groups on the gel surface and reactive terminal groups of the preformed polymer (so called grafting to). The obvious advantage here is that one can beforehand determine the properties (molecular mass, MW distribution) of the to-be-grafted polymer. The problem is that the hydrogel should have reactive groups suitable for grafting and the grafted chain should carry the proper functionality at the end. It is very difficult to achieve high grafting densities using the grafting to methods because of steric crowding of reactive sites at the gel surface by already bound polymer molecules. Moreover, the efficiency of grafting to methods is pretty low resulting in pronounced losses of the terminally modified polymer.

Surface-initiated polymerization using initiator bound to surface (also called grafting from), is a powerful alternative to control the density and thickness of polymer brushes. It requires the formation of active sites on the backbone of the hydrogel-forming polymer, the desired polymerization being initiated from these active sites. During the polymerization reaction, the polymer chains “grow” from the surface. Graft-type hydrogel with long chains and high density of polymer grafted can be prepared in this way. Some un-grafted polymer is, how ever, also formed in solution during the reaction thus decreasing the grafting efficiency. Using Ce(IV) as initiator is a widely used approach for graft polymerization of various vinyl monomers onto hydrogels containing hydroxyl or epoxy groups. The density of hydroxyl groups on the support surface and the amount of catalyst used determine the density of the grafting. Hydrogels with high graft density were prepared by using this method [Müller W., J. Chromatogr. 1990; 510 (1):133-140.].

With grafting from approach, grafting is expected to occur mainly at the interface of the hydrogel and the liquid phase, as the diffusion of the monomers inside the gel phase is restricted, especially for gels with high polymer density. Thus with high density of the gel phase, grafting takes place mainly at the gel-liquid interface.

Abeer Abd El-Hadi (Process Biochemistry 38 (2003) 1659-166) discloses the preparation of a macroporous hydrogel, cryogel), with a cross-linked network of N-IPAAm and HEMA copolymer within the pores of PVA cryogel as the result of polymerization by γ-irradiation. This formation of a cross-linked network inside the pores resulted in poor flow of the liquid through the material which explains the authors choice to cut the material into small (2-3 mm in diameter) granulates (page 1660) rather than using an originally produced material which could be a natural choice.

### SUMMARY OF THE INVENTION

In accordance with the present invention it was found that the grafting degree when grafting polymer chains to a hydrogel using the grafting from approach may be improved by using a macroporous cryogel as said hydrogel.

The grafting method of the present invention results in the production of brushes of grafted polymers at the surface of pore walls. The modification of pore walls with polymer brushes according to the invention does not interfere with the liquid flow through the porous materials thus allowing, for example, passage of cell suspension through the materials. The method according to the invention allows fine tuning of the density and thickness of the polymer brushes apart of their chemical composition, whereas the method disclosed by Abeer Abd El-Hadi allows only variations in the chemical composition of the cross-linked polymer network. The materials produced by the method according to the present invention and by the method disclosed by Abeer Abd El-Hadi are designed for different purposes. The materials produced by the method disclosed by Abeer Abd El-Hadi are used for immobilization of cells ensuring, that the cells are entrapped within the material, whereas the materials produced according to the method according to the invention are used for separation of proteins and cells ensuring that cells could pass easily through the pores and interact in a predetermined way with the polymer brushes.

Thus in accordance with a first aspect of the present invention there is provided a macroporous cryogel having grafted thereon polymer chains formed by polymerizing at least one monomer on said macroporous cryogel.

In accordance with another aspect of the present invention there is provided a method for graft (co)polymerization of a monomer or monomers on a macroporous cryogel wherein potassium diperiodatocuprate is used as an initiator.

In accordance to a further aspect of the present invention there is provided the use of the macroporous cryogels according to the invention in separation processes.

### DETAILED DESCRIPTION OF THE INVENTION

In accordance with a first aspect of the present invention there is provided a macroporous cryogel having grafted thereon polymer chains formed by polymerizing at least one monomer of the general formula (I)

CR₁R₂═CR₃R₄ (I)

wherein R₁ and R₂ are equal or different and each represents a hydrogen atom or a substituent group which is not detrimental to the polymerization reaction; and
R₃ and R₄ each represents a hydrogen atom or a substituent group which is not detrimental to the polymerization reaction, provided that R₃ and R₄ are not both a hydrogen atom, on said macroporous cryogel.

In formula (I) above symbols R₁ and R₂ may, for instance, both represent a hydrogen atom or one of R₁ and R₂ represents a hydrogen atom and the other represents a substituent selected from the group consisting of alcohols, organic acids, ethers, esters, amides and N-substituted amides thereof, amines, N-substituted amines, heterocyclic aromatic rings and derivatives thereof.

As to symbols R₃ and R₄ of formula (I) above, one of R₃ and R₄ may represent a hydrogen atom or an alkyl group of 1 to 3 carbon atoms and the other is a member selected from the group consisting of a carboxylic group and derivatives such as alcohols, organic acids, ethers, esters, amides and N-substituted amides thereof, amines, N-substituted amines, heterocyclic aromatic rings, etc.

A particularly interesting meaning of one of R₃ and R₄ is a derivative containing an affinity ligand bound thereto.

A preferred class of monomers of formula (I) comprises acrylic (R₁═R₂═R₃═H) and methacrylic acids (R₁═R₃═H; R₂═CH₃)(R₄═COOH) and derivatives such as esters and amides of said acids.

Examples of monomers of the general formula (I) to be used in the present invention include, but are not limited to acrylic acid (AAc), methacrylic acid (MAC), N,N-dimethyl-aminoethylmethacrylate (DMAEMA), (2-(methacryloyloxy)ethyl)-trimethyl ammonium chloride (META), N-isopropylacrylamide (NIPAM), N-vinyl imidazole (VI), glycidylmethacrylate (GMA), hydroxyethyl methacrylate (HEMA), acrylamide, methylene-bis-acrylamide (MBAA) diallyltartaramide (DATAm), diallylacryalamide (DAAm), polyethyleneglycol di(meth)acrylate (PEGD(M)A), polypropylene glycol diglycidyl ether (PEG-DGE), 3-(acrylamido)phenylboronic acid (APBA) and derivatives thereof.

Macroporous cryogels and processes for their preparation have been described previously. Reference may, for instance, be made to WO 03/041830 A2, the disclosure of which is hereby incorporated herein in its entirety by reference.

According to WO 03/041830 A2 cryogels may be prepared by polymerizing an aqueous solution of one or more water-soluble monomers selected from the group consisting of:

N-substituted and non-substituted (meth)acrylamides;
N-alkyl substituted N-vinylamides;
Hydroxyalkyl (meth)acrylates;
vinylacetate;
alkylethers of vinyl alcohols;
ringsubstituted styrene derivatives;
vinyl monomers;
(meth)acrylic acid and salts thereof;
silicic acids and
monomers capable of forming polymers via polycondensation;
under freezing at a temperature below the aqueous solvent crystallization point, at which solvent in the system is partially frozen with the dissolved substances concentrated in the non-frozen fraction of solvent to the formation of a cryogel.

According to a preferred embodiment of the macroporous cryogel according to the invention the basic cryogel on which to graft polymer chains by polymerization monomers thereon is a cryogel prepared by copolymerizing monomers selected from the group consisting of acrylic acid and derivatives thereof, one of said monomers being an acrylamide. Preferably, said basic macroporous cryogel is a cryogel prepared by radical copolymerization of acrylamide and N,N′-methylene-bis-acrylamide.

According to another embodiment of the macroporous cryogel according to the invention the basic cryogel on which to graft polymer chains by polymerizing monomers thereon is a poly(vinyl alcohol) cryogel cross-linked by means of a bifunctional reagent, e.g. glutaraldehyde, and said at least one monomer of the general formula (I) is a member selected from the group consisting of alcohols, organic acids, ethers, esters, amides and N-substituted amides thereof, amines, N-substituted amines, heterocyclic aromatic compounds, all containing a polymerizable double bond.

The cryogel according to the present invention is preferably in the shape of a monolith.

Monoliths of the basic cryogel on which to graft polymer chains by polymerizing monomers according to the invention may be prepared, e.g. by using methods such as those disclosed in WO 2004/087285 A1, the disclosure of which is hereby incorporated herein in its entirety by reference. Alternatively, a cryogel monolith may simply be prepared by preparing an aqueous solution of the starting monomers in a tube and freezing the tube at a temperature below the aqueous solvent crystallization point at which solvent in the system is partially frozen with the dissolved substances concentrated in the non-frozen fraction of solvent to the formation of a cryogel whereafter thawing and washing of the cryogel matrix thus obtained is carried out.

Monoliths of cryogels are also commercially available, e.g. a polyacrylamide based cryogel monolith from Protista Biotechnology AB, Lund, Sweden.

According to another aspect of the invention there is provided a method for graft (co)polymerization of at least one monomer of the general formula (I)

CR₁CR₂═CR₃R₄ (I)

wherein R₁, R₂, R₃ and R₄ are as defined above, on a macroporous cryogel, which process comprises reacting said at least one monomer of the general formula (I) as defined above with a macroporous polyacrylamide cryogel in the presence of potassium diperiodatocuprate as an initiator.

According to an embodiment of the method according to the present invention a dry macroporous polyacrylamide cryogel is contacted with an alkaline aqueous solution of said at least one monomer of the general formula (I) and diperiodactocuprate.

According to another embodiment of the method according to the present invention a dry macroporous polyacrylamide cryogel is saturated with an alkaline aqueous solution of potassium diperiodatocuprate in a column whereafter said alkaline aqueous solution is displaced from the cryogel by passing an aqueous or aqueous-organic solution of said at least one monomer of the general formula (I) therethrough whereafter graft (co)polymerization is allowed to proceed.

The alkaline aqueous solutions to be used in these embodiments of the method according to the invention are preferably made alkaline by means of an alkali metal hydroxide, preferably sodium hydroxide. The concentration of alkali metal hydroxide and the alkali metal hydroxide to monomer ratio was found to influence considerably upon graft polymerization parameters such as grafting degree and density of grafted polymer chains. Thus the grafting degree and the density of grafted chains may be increased significantly by increasing the alkali metal hydroxide:monomer ratio up to a certain ratio giving a maximum value of the grafting degree and density of grafted chains or where the grafting degree and density of grafted chains plateaus. The optimum ratio in each specific case depends on the specific components of the system used, i.e. alkali metal hydroxide, monomer or monomers and macroporous polyacrylamide cryogel on which grafting is carried out. A useful ratio for use in the method according to the present invention may easily be estimated without undue experimentation by means of a series of experiments wherein the alkali metal hydroxide to monomer ratio is varied. For instance, in case of the system comprising grafting acrylic acid from an aqueous solution thereof containing sodium hydroxide onto a macroporous polyacrylamide gel an appropriate molar ratio of NaOH:acrylic acid for use in the method according to the present invention would generally be within the range of from 2:1 to 8:1, preferably from 3:1 to 7:1 and more preferably from 4:1 to 6:1.

The grafting degree is also depending on the reaction temperature used. The grafting degree may be increased by increasing the reaction temperature until a maximum grafting degree is obtained. Further increase in the reaction temperature will result in a decrease in the grafting degree and the density of grafting probably due to an increased rate of termination of grafted polymer chains. The optimum reaction temperature will vary with the specific system used. Thus in a series of experiment wherein acrylic acid was grafted onto a macroporous polyacrylamide cryogel at different temperatures ranging from 25° C. to 75° C., respectively, the grafting degree increased with increasing the temperature from 25° C. to 45° C., whereafter an increase in the reaction temperature resulted in a decrease in the grafting degree and the density of grafting.

The grafting degree may also be influenced upon by varying the initiator concentration of the reaction solution. Thus the grafting degree will increase with increasing initiator concentration up to a value where it plateaus.

According to a further aspect of the present invention there is provided the use of the macroporous cryogel according to the invention in a separation process.

Based on the different monomers used in the grafting process and possible modifications of the chains after the grafting the macroporous hydrogels of the present invention may be used in all types of separation processes in which the basic macroporous cryogel may be used.

Examples of separation processes in which the claimed macroporous cryogels may be used include, but are not limited to the separation of proteins, inclusion bodies, plasmid DNA, viruses, cell organelles, microbial and mammalian cells.

In accordance with an embodiment of the use according to this aspect of the invention the macroporous cryogel according to the invention is a macroporous polyacrylamide cryogel carrying tertiary and quarternary amino groups prepared by graft polymerization of a monomer selected from the group consisting of N,N-dimethylaminoethyl methacrylate (DMAEMA) and (2-(methacryloyloxy)ethyl)-trimethyl ammonium chloride onto the surface of said polyacrylamide cryogel, and wherein said macroporous cryogel is used to chromatography of RNA and gDNA.

The present invention will now be further illustrated by means of a number of working examples which are for illustrative purpose only and should not be construed as limiting the invention.

### EXAMPLE 1

### Graft Polymerisation of Acrylic Acid onto Macroporous Polyacrylamide (pAAm) Cryogel

### A. Preparation of Macroporous Cryogel

The macroporous cryogel was prepared in a glass tube by copolymerizing in an aqueous solution acrylamide (AAm, more than 99.9% purity) and methylene-bis-acrylamide (MBAA) in the presence of N,N,N′,N′-tetramethylethylenediamine (TEMED) and ammonium persulfate (APS) using a AAm/MBAA ratio of 8:1, a total concentration of AAm+MBAA=6% by weight of the solution and an amount of TEMED as well as APS of each 1.2% by weight calculated on the total weight of AAm+MBAAm. The reaction solution in the tube was frozen at −12° C. and kept at this temperature for 20 h. After thawing and washing with water (200 ml) the gel matrix (AAm-cryogel monolith) thus obtained was dried at 60° C. and stored in dry state.

### B. Preparation of Potassium Diperiodatocuprate (Cu(III)) Solution

A Cu(III) solution was prepared as follows; CuSO₄ 5H₂O (3.54 g), KIO₄ (6.82 g), K₂S₂O₈ (2.20 g) and KOH (9.00 g) were added to 200 ml of deionised water. The mixture was boiled for 40 minutes. After cooling to room temperature, the mixture was filtered and the filtrate was diluted to 250 ml with deionised water. The final concentration of Cu(III) was 0.0562 M.
   C. Graft Polymerization of Acrylic Acid (AAc) onto Polyacrylamide (pAAm) Cryogel Monolith
Appropriate amounts of acrylic acid (AAc) and NaOH were mixed and the reaction solution was flashed with nitrogen for 10 min before Cu(III) solution was added. The total volume was adjusted to 10 ml with deionised water. Dry pAAm-cryogel (0.15±0.03 g), prepared according to section A above, was soaked in the reaction solution. Polymerization was carried out for 2 hours at a defined temperature. The graft copolymerization was performed using different concentrations of NaOH, AAc and initiator and temperature. After the reaction was finished, the cryogels were washed with 0.1 M HCl followed by washing with an excess of hot deionised water.
   D. Binding of Cu(III) and Lysozyme by AAc-Grafted pAAm Cryogel
Cu(II) binding was measured by saturating AAc-grafted pAAm cryogel with different degrees of grafting with a solution of 0.2 M CuSO₄ washing unbound Cu(II) ions with water elution of bound Cu(II) ions with 0.1 M EDTA pH 7.3. Lysozyme binding was measured by saturating AAc-grafted pAAm cryogel with lysozyme (1 mg/ml in 20 mM Tris-HCl buffer, pH 7.0) washing unbound lysozyme and elution with 1.5 M NaCl in 20 mM Tris-HCl buffer, pH 7.0.
The grafting is presented as grafting degree (G), density of AAc grafting (D) and grafting yield (E) of the grafting polymerization were defined and calculated as follows:

G (%)=[(W₁−W₀)/W₀]×100%,

D₁ (mmol/g)=[(W₁−W₀)/W₁]×(1000/M_{AAc}),

E (%)=(W₁−W₀)/W₂×100%,
where W₀ and W₁ are the weights (g) of original and grafted samples, respectively and W₂ is a weight (g) of AAc added; M_{AAc} is the molecular weight of AAc, 72 Da. Alternatively, density of AAc grafting, D₂ was calculated from titration of grafted carboxyl groups of AAc with NaOH and determined as mmole of carboxyl groups per gram of dried cryogel.

The results are reported in Tables 1 to 6 below.

TABLE 1
Effect of NaOH on AAc grafting onto pAAm cryogel.

| Ratio | | | |
|---|---|---|---|
| NaOH/AAc | | D₁²⁾ | D₂³⁾ |
| mole/mole | G¹⁾ % | mmol/g | mmol/g |
| 1.2 | 4 | 0.6 | 2.6 |
| 2.4 | 17 | 2.3 | 4.6 |
| 3.5 | 30 | 4.2 | 6.0 |
| 4.8 | 47 | 6.5 | 7.0 |
| 6.6 | 45 | 6.3 | 7.4 |

Legend:
¹⁾Degree of grafting
²⁾Density of grafting calculated gravimetrically
³⁾Density of grafting calculated by pH titration
Reaction conditions: Cu(III) concentration 0.021 M, AAc concentration 0.5 M, 45° C.

TABLE 2
Effect of temperature on AAc grafting onto pAAm cryogel.

| Temperature | | D₁²⁾ | D₂³⁾ |
|---|---|---|---|
| ° C. | G¹⁾ % | mmol/g | mmol/g |
| 28 | 30 | 4.2 | 5.0 |
| 35 | 37 | 5.1 | 5.5 |
| 45 | 47 | 6.5 | 7.0 |
| 60 | 32 | 4.4 | 7.0 |
| 75 | 20 | 2.7 | 7.7 |

Legend:
Vide Table 1 above.
Reaction conditions: Cu(III) concentration 0.021 M, AAc concentration 0.5 M, NaOH/Aac = 4.8 mole/mole.

TABLE 3
Effect of initiator [Cu(III)] concentration on AAc grafting
onto pAAm cryogel.

| | | D₁²⁾ | D₂³⁾ |
|---|---|---|---|
| Initiator M | G¹⁾ % | mmol/g | mmol/g |
| 0.0035 | 21 | 2.9 | 5.5 |
| 0.007 | 35 | 4.9 | 5.8 |
| 0.014 | 46 | 6.4 | 6.3 |
| 0.021 | 48 | 6.6 | 6.8 |
| 0.0336 | 48 | 6.7 | 7.0 |

Legend:
Vide Table 1 above.
Reaction conditions: AAc concentration 0.5 M, NaOH/AAc = 4.8 mole/mole, 45° C.

TABLE 4
Effect of AAc concentration on AAc grafting onto pAAm cryogel.

| | | D₁²⁾ | D₂³⁾ |
|---|---|---|---|
| Acrylic acid M | G¹⁾ % | mmol/g | mmol/g |
| 0.17 | 7 | 0.9 | 3.6 |
| 0.33 | 27 | 3.8 | 5.3 |
| 0.5 | 47 | 6.5 | 7.0 |
| 0.7 | 62 | 8.6 | 9.0 |
| 1.0 | 69 | 9.4 | 9.6 |

Legend:
Vide Table 1 above.
Reaction conditions: Cu(III) concentration 0.021 M, NaOH/AAc = 4.8 mole/mole, 45° C.

TABLE 5
Effect of AAc concentration on grafting degree (G) and grafting
yield (E)

| Acrylic acid M | G % | E % |
|---|---|---|
| 0.17 | 7 | 9.3 |
| 0.33 | 27 | 18.6 |
| 0.5 | 47 | 22.0 |
| 0.7 | 62 | 24.6 |
| 1.0 | 69 | 15.5 |

TABLE 6
Binding of Cu (II) and lysozyme by AAc-grafted pAAm cryogel
with different degrees of grafting.

| | Density of AAc | Binding capacity | Binding capacity |
|---|---|---|---|
| Grafting degree, | grafting, | for Cu⁺², | for lysozyme, |
| G % | mmol/g | mmol/g | mg/g |
| 6 | 0.9 | 4.0 | 13 |
| 17 | 1.5 | 4.5 | 18 |
| 30 | 1.9 | 5.5 | 19 |
| 44 | 2.5 | 6.5 | 25 |
| 69 | 3.7 | 9.4 | 72 |
| 70 | 3.8 | 9.6 | 108 |

### EXAMPLE 2

### Graft Polymerization of N,N-dimethylaminoethylmethacrylate (DMAEMA) onto Macroporous Polyacrylamide (pAAm) Cryogel

For this experiment pAAm cryogel monoliths and potassium diperiodatocuprate solutions prepared as described in Sections A and B, respectively, of Example 1 were used.

### A. Graft Polymerization Using One Step Technique

A dried pAAm cryogel monolith (0.15±0.03 g) was submerged into 10 ml of reaction solution of monomer and initiator [Cu(III)0.008 M]. The reaction mixture was flashed with nitrogen for 10 min before Cu(III) solution was added. Polymerization was carried out for 2 hours at 45° C.

### B. Graft Polymerization Using Two Steps Technique

A dried pAAm cryogel monolith as in Section A above was placed in a glass tube and saturated with 5 ml of 0.033 M Cu(III) solution in 1 M NaOH. The dry cryogels rehydrated within less then a minute after contact with aqueous solution filling up the glass tubes so that the liquid was passing through the interconnected porous system of the monolith. The samples saturated with Cu(III) were incubated at 40° C. for 30 min. Then the initiator system was displaced from the cryogel with 8 ml of degassed monomer solution that was passed through the cryogel matrix at a flow rate of 4 ml/min. The flow was stopped with a cork. The graft polymerization proceeded at 40° C. for 1 h.
After completion of the reactions in Sections A and B above, the cryogels were washed with 30 ml 0.1 M HCl followed by washing with an excess of deionized water. The washings containing homopolymer were collected and any remaining monomer was removed by dialyzing against water for 30 h. The water was changed in the meantime 4 times. The final homopolymer was then freeze-dried to the constant weight under vacuum.
The grafting degree (G), grafting efficiency (EG) and monomer conversion (C) of the graft polymerization were defined and calculated as follows:

G (%)=[(W₁−W₀)/W₀]×100%,

EG (%)=(W₁−W₀)/[(W₁−W₀)+W₂]×100%,

C (%)=[(W₁−W₀)+W₂]/W₃×100%,
where W₀ and W₁, are the weights (g) of original and grafted samples, W₂ and W₃ are the weights (g) of homopolymer and monomer used, respectively.

The results obtained by using a number of different concentrations of DMAEMA in the reaction solution, are reported in Tables 7 to 10 below.

TABLE 7
Effect of DMAEMA concentration on DMAEMA grafting
onto pAAM cryogel.

| A. Grafting in one step | | B. Grafting in two steps | |
|---|---|---|---|
| Concentration | Grafting degree | Concentration | Grafting degree |
| of DMAEMA M | (G) % | of DMAEMA M | (G) % |
| 0.15 | 17 | 0.14 | 13 |
| 0.23 | 30 | 0.29 | 24 |
| 0.29 | 38 | 0.47 | 34 |
| 0.38 | 45 | 0.58 | 37 |

TABLE 8
Efficiency of graft polymerization of DMAEMA onto
pAAm cryogel.

| A. Grafting in one step | | | |
|---|---|---|---|
| Concentration | | B. Grafting in two steps | |
| of | Grafting | Concentration | Grafting |
| DMAEMA M | efficiency (EG) % | of DMAEMA M | efficiency (EG) % |
| 0.23 | 14 | 0.18 | 45 |
| 0.46 | 10 | 0.36 | 60 |
| 0.91 | 11 | 0.73 | 56 |
| 1.34 | 4 | 0.91 | 52 |
| 1.82 | 13 | 1.46 | 55 |
| | | 1.82 | 50 |

TABLE 9
Conversion of monomer to polymer for graft polymerization of
DMAEMA onto pAAm cryogel

| A. Grafting in one step | | B. Grafting in two steps | |
|---|---|---|---|
| Concentration | Monomer | Concentration | Monomer |
| of DMAEMA M | conversion % | of DMAEMA M | conversion % |
| 0.23 | 73 | 0.18 | 17 |
| 0.46 | 72 | 0.36 | 12 |
| 0.91 | 65 | 0.73 | 15 |
| 1.34 | 55 | 0.91 | 12 |
| 1.82 | 58 | 1.46 | 5 |
| | | 1.82 | 10 |

TABLE 10
Homopolymer formation during graft polymerization of
DMAEMA onto pAAm cryogel

| A. Grafting in one step | | B. Grafting in two steps | |
|---|---|---|---|
| | Concentration | | Concentration |
| | of poly- | | of poly- |
| Concentration | DMAEMA | Concentration | DMAEMA |
| of DMAEMA M | g/l | of DMAEMA M | g/l |
| 0.23 | 63 | 0.18 | 10 |
| 0.46 | 64 | 0.36 | 5 |
| 0.91 | 55 | 0.73 | 6 |
| 1.34 | 41 | 0.91 | 6 |
| 1.82 | 51 | 1.46 | 2 |

From Tables 7 to 10 above it is seen that it was possible to achieve up to 110% (w/w) DMAEMA grafting on pAAm cryogel. The graft density of pAAm cryogels grafted with DMAEMA increased with increasing the monomer concentration as is seen from Table 7.

The direct graft polymerization of DMAEMA onto pAAm cryogel by submerging dry pAAm cryogel directly in the reaction mixture containing initiator and monomer (method A above) entailed the formation of a large amount of homopolymer (Table 10A). The amount of homopolymer increased with increasing the monomer concentration. Potassium diperiodatocuprate initiated also the homopolymerization of DMAEMA as there was an intensive homopolymer formation when the potassium diperiodatocuprate was added to the monomer solution (data not reported). Thus, during the graft polymerization by submerging of dry pAAm cryogel in solution of monomer and initiator the generation of radicals proceeded both onto pAAm backbone and in solution. That resulted in an intensive homopolymer formation during graft polymerization thereby decreasing the efficiency of graft polymerization. The efficiency of graft polymerization with respect to the total polymer formation was only 10% at 60-70% monomer conversion (Table 8A). It was mostly the homopolymer which was formed during the direct graft polymerization by submerging of dry cryogel in the monomer containing reaction mixture.

The two-step graft polymerization (method B above) via activating the polymer matrix first and then via saturation with the monomer solution, allowed to avoid the intensive homopolymer formation during the graft polymerization (Table 10B). The radicals are generated only on the pAAm cryogel surface. The polymerization of DMAEMA was initiated from the active center onto gel surface restricting the formation of homopolymer in solution and increasing the efficiency of graft polymerization up to 50% (Table 8B). However, the utilization of monomer for polymerization decreased. The monomer conversion was only 10-15% (Table 9B) for two-step procedure as compared to 60-70% (Table 9A) for the one-step direct graft polymerization.

The activation conditions in two-step procedure were optimized for the maximal efficiency of radical generation. However, even under optimal conditions, the grafting percentage was lower as compared to direct grafting (Table 7). The decrease of graft density for two-step graft polymerization is presumably due to the contact of monomer solution with less radical sites on the pAAm backbone as the initiator has been already removed when cryogel came into contact with the monomer solution and the possibility for free radicals to get quenched by impurities and oxygen entered with monomer solution.

### EXAMPLE 3

### Graft Polymerization of N-isopropylacrylamide (NIPAM) and N-vinyl Imidazole (VI) onto PolyAAm Cryogel

PolyAAm cryogel monoliths were prepared using 4.7% solution of co-monomers (AAm/MBAAm=4:1). Cu(III) stock solution was prepared as follows: 50 ml of deionized water containing CuSO₄ (0.885 g), KIO₄ (1.705 g), K₂S₂O₈ (0.55 g), KOH (2.25 ml) was boiled for 40 min, the volume was adjusted to 62.5 ml. Three ml of the Cu(III) stock solution was mixed with 7 ml of deionized water containing different concentrations of NIPAM (for graft polymerization of NIPAM-VI onto polyAAm cryogel, 0.5 ml of VI were added to the reaction mixture). Cryogel monoliths were equilibrated with the obtained NIPAM/initiator solution (2 ml were passed though each monolith), incubated overnight at 20 or 37° C., washed with 0.1 M HCl and deionized water and dried at 60° C.

The following grafting parameters were calculated:

Grafting percentage G %=(W₁−W₀)/W₀×100%

Efficiency of the grafting polymerization E %=(W₁−W₀)/W₂×100%,

where W₀ and W₁ are the weight (g) of the original and grafted sample of dry cryogel monolith and W₂ is a weight (g) of NIPAM added. The results are presented in Tables 11 and 12.

The flow properties of NIPAM-cryogels were estimated by measuring the time required for 1 ml of liquid to pass through the monolith at 20 and 37° C.

Hydrophobic properties of NIPAM-cryogels were estimated by analyzing adsorption of BSA to the monoliths at 37° C. 0.2 ml of BSA solution (2 mg/ml) in potassium phosphate buffer pH 7.2 containing 2 M (NH₄)₂SO₄ (buffer A) were applied to the monoliths equilibrated with buffer A at 37° C. followed by washing with 1.5 ml of warm buffer A. Bound protein was eluted with buffer A not containing (NH₄)₂SO₄ at room temperature. The elution resulted in almost quantitative recovery of the protein. The results are presented in Table 11.

Suspension of yeast cells (OD₆₀₀=1.21) was applied to NIPAM-cryogel monoliths (0.2 ml per monolith) equilibrated with potassium phosphate buffer pH 7.2 at 20 and 37° C. Non-retained cells were washed with 4 ml of the buffer. The amount of bound cells was calculated as a difference between the amount of applied and non-bound cells. Amount of applied cells was taken as 100%. The results are presented in Table 11.

TABLE 11
Graft polymerization of NIPAM onto polyAAm cryogel
(4.7%) monoliths (0.5 ml bed volume).

| Grafting | | | | | Retained | |
|---|---|---|---|---|---|---|
| conditions | | | | Bound | yeast | |
| [NIPAM], | | | | BSA, | cells, % | |
| mg/ml | t, ° C. | G % | E % | μg/ml | 20° C. | 37° C. |
| 35 | 20 | 15 | 16 | 44 | 0 | 15 |
| 70 | 20 | 44 | 25 | 78 | 13 | 25 |
| 100 | 20 | 74 | 33 | 216 | 12 | 21 |
| 140 | 20 | 173 | 49 | 446 | 19 | 27 |
| 90 | 20 | 65 | 29 | 224 | 11 | 17 |
| 90 | 37 | 122 | 73 | 440* | 15 | 18 |

*eluted protein was aggregated; bound protein was calculated as a difference between amounts of applied and non-bound protein.

TABLE 12
Graft polymerization of NIPAM-VI onto polyAAm cryogel
(4.7%) monoliths (0.5 ml bed volume).

| [NIPAM], | | | | Cu (II), |
|---|---|---|---|---|
| mg/ml | t, ° C. | G % | E % | μmol/ml |
| 140 | 20 | 21 | 6 | 19 |
| 150 | 37 | 70 | 20 | 25 |

### EXAMPLE 4

### Graft Polymerization of Glycidylmethacrylate (GMA) in Aqueous-Organic Medium

Dried polyAAm cryogels prepared as described in Example 1 (2 ml bed volume) were placed in a glass tube and saturated with 4 ml mixture composed of 2 ml of Cu(III) stock solution (prepared as in Example 3) 1 ml distilled water and 1 ml 5 M NaOH alternatively 1 ml 5 M NaCl solution. Samples were incubated at 40° C. for 30 min. Samples were incubated at 40° C. for 30 min. Then, 5 ml GMA solutions of different concentration in 70% aqueous DMSO was passed through the column at a flow rate 2 ml/min. The glass tubes were sealed with a cork and incubated at 80° C. for 4 h.

The grafting percentage, G % was calculated as in Example 3. The results are presented in Table 13.

TABLE 13
Graft polymerization of glycidylmethacrylate (GMA)
in aqueous-organic medium onto polyAAm cryogel monoliths
(2 ml bed volume).

| Activation in | | |
|---|---|---|
| the presence | | |
| of | [GMA], M | G % |
| 0.8 M NaOH | 0.36 | 62 |
| | 0.61 | 110 |
| | 0.85 | 155 |
| | 1.22 | 157 |
| 0.8 M NaCl | 0.12 | 16 |
| | 0.61 | 123 |

### EXAMPLE 5

### Graft Polymerization of (2-(methacryloyloxy)ethyl) trimethyl-ammonium Chloride (META)

PolyAAm cryogels (2 ml bed volume) were prepared using 6% solution of co-monomers (AAm/MBAAM=8/1). The dried cryogels were placed in glass tubes and saturated with 3.35 ml of solution contained 2 ml of Cu(III) stock solution, 1 ml H₂O and 0.35 ml of 10 M NaOH. Samples were incubated at 40° C. for 30 min. Then 8 ml of the META aqueous solution was passed through the cryogel with flow rate 4 ml/min. Glass tube was sealed with a cork and placed in water bathe at 40° C. for 2 h. Then cryogels were washed with 0.1 M HCl and excess of water. The grafting percentage, G % was calculated as in Example 3. The results are presented in Table 14.

TABLE 14
Graft polymerization of META

| META, M | G % |
|---|---|
| 0.26 | 15 |
| 0.53 | 21 |
| 1 | 43 |
| 2 | 58 |

The dried cryogels was submerged in the 8 ml of reaction solution contained monomer, 1.5 ml of Cu(III) and 0.5 ml of 10 M NaOH. Samples were incubated at 40° C. for 2 h. The grafting percentage, G % was calculated as in Example 3. The results are presented in Table 15.

TABLE 15
Graft polymerization of META

| META, M | G % |
|---|---|
| 0.8 | 16 |
| 1.6 | 58 |

### EXAMPLE 6

### Graft Copolymerization of NIPAM with AAc

The dried cryogels prepared as in Example 5 were placed in glass tubes and saturated with 3.35 ml contained 2 ml of Cu(III) stock solution (prepared as in Example 3), 1 ml of water and 0.35 ml of 10 M NaOH. The samples were incubated at 40° C. for 30 min. Then the 8 ml of degassed monomer solution (AAc+NIPAM=1 M) was passed through the cryogel matrix. NaOH in equivalent amount to that of AAc was added to monomer solution to adjust the pH of monomer solution to pH 7.0±0.5. The flow of monomer through the cryogel was stopped with a cork. The graft polymerization proceeded for 2 h. After completion of the reaction, the cryogels were washed with 30 ml 0.1 M HCl followed by washing with an excess of deionized water.

The grafting percentage, G % was calculated as in Example 3. The results are presented in Table 16.

Chromatography of lysozyme was monitored using a LKB UVI-cord with a 276 nm filter. A monolith of grafted cryogel was put into a glass column (inner diameter 10 mm, 2 ml volume) equipped with upper and lower adapters. Lysozyme solution (1 mg/ml in running buffer, 20 mM Tris-HCl buffer, pH 7.0) was applied to the column followed by washing with running buffer until the absorbance of the eluate at 276 nm was down to baseline. Elution was performed with 1.5 M NaCl in running buffer. Fractions of 3 ml were collected and optical density at 280 nm was measured. Lysozyme content was calculated using a calibration curve for lysozyme (0.1-1 mg/ml) established at 280 nm. The results are presented in Table 16.

TABLE 16
Graft copolymerization of NIPA with AAc

| | | | Capacity of | |
|---|---|---|---|---|
| | | | Lysozyme at | |
| Temperature | | | 30% break- | Capacity of |
| of graft | AAc/NIPA | | through, | CuSO4, |
| polymerization | concentration, % | G % | mg/ml | μmol/ml |
| 20° C. | 0/100 | 1 | | 18 |
| | 18/82 | 70 | 0.24 | 20 |
| | 36/64 | 42 | 0.25 | 38 |
| | 55/45 | 16 | 0.25 | 45 |
| | 73/27 | 7 | 0.3 | 53 |
| | 100/0 | 6 | 0.18 | 52 |
| 40° C. | 18/82 | 53 | 0.46 | 22 |
| | 36/64 | 58 | 0.46 | 23 |
| | 55/45 | 37 | 0.5 | 80 |
| | 73/27 | 16 | 0.8 | — |
| | 100 | 9 | 0.6 | 63 |

### EXAMPLE 7

### Graft Copolymerization of dimethyl-aminoethylmethacrylate (DMAEM) with NIPA

The dried cryogels prepared as in Example 5 were placed in glass tubes and saturated with 3.35 ml contained 2 ml of Cu(III) stock solution (prepared as in Example 3), 1 ml of water and 0.35 ml of 10 M NaOH. The samples were incubated at 40° C. for 30 min. Then the 8 ml of degassed monomer solution (DMAEMA+NIPA) was passed through the cryogel matrix. The flow of monomer through the cryogel was stopped with a cork (method I).

Alternatively dried cryogels prepared as in Example 5 were submerged in 10 ml of reaction solution contained monomers and 3 ml of Cu(III) stock solution (prepared as in Example 3) (method II). The samples were incubated at 40° C. for 2 h. After completion of the reaction, the cryogels were washed with 30 ml 0.1 M HCl followed by washing with an excess of deionized water.

The grafting percentage, G % was calculated as in Example 3. The results are presented in Table 17.

Chromatography of BSA was monitored using a LKB UVI-cord with a 276 nm filter. A monolith of grafted cryogel was put into a glass column (inner diameter 10 mm, 2 ml volume) equipped with upper and lower adapters. BSA solution (1 mg/ml in running buffer, 20 mM Tris-HCl buffer, pH 7.0) was applied to the column followed by washing with running buffer until the absorbance of the eluate at 276 nm was down to baseline. Elution was performed with 1.5 M NaCl in running buffer. Fractions of 3 ml Were collected and optical density at 280 nm was measured. BSA content was calculated using a calibration curve for lysozyme (0.1-1 mg/ml) established at 280 nm.

TABLE 17
Graft copolymerization of NIPA with DMAEM

| | | | | | Capacity |
|---|---|---|---|---|---|
| | | | | | for BSA, |
| | Grafting | | | | per ml of |
| Method | time, h | NIPAAM, M | DMAEMA, M | G % | gel |
| I | 20 | 0.22 | 0.48 | 39 | |
| I | 20 | 0.22 | 0.24 | 16.8 | |
| I | 2 | 0.11 | 0.16 | 6 | 0.5 |
| I | 2 | 0.06 | 0.16 | 6 | 0.24 |
| II | 20 | 0.22 | 0.48 | 55 | 0.8 |

### EXAMPLE 8

### Graft Polymerization of Hydroxyethyl Methacrylate (HEMA)

The Dried Cryogels Prepared as in Example 5 were Placed in glass tubes and saturated with 3.35 ml contained 2 ml of Cu(III) stock solution (prepared as in Example 3), 1 ml of water and 0.35 ml of 10 M NaOH. The samples were incubated at 40° C. for different periods of time. Then the 8 ml of degassed HEMA solution of different concentrations was passed through the cryogel matrix. The flow of monomer through the cryogel was stopped with a cork. After completion of the reaction, the cryogels were washed with 30 ml 0.1 M HCl followed by washing with an excess of deionized water. Then column was soaked in 90% of ethanol for 20 h, washed with 50% of ethanol and water again.

The grafting percentage, G % was calculated as in Example 3. The results are presented in Table 18.

TABLE 18
Graft polymerization of hydroxyethyl methacrylate
(HEMA)

| Activation | Graft polymerization | | |
|---|---|---|---|
| time | time | HEMA, % v/v | G % |
| 30 min | 1 | 12.5 | 34 |
| 30 min | 4 | 25 | 130 |

Iminodiacetic acid (IDA) was covalently coupled to the HEMA-grafted cryogel as follows. HEMA-grafted cryogel was incubated with the suspension of 2.2 ml epichlorohydrin in 20 ml 1 M NaOH containing 0.07 g sodium borohydride. Then, 20 ml 0.5 M IDA solution in 1 M Na₂CO₃ pH10 was re-circulated through the cryogel column overnight at a flow rate of 1 ml/min. The prepared IDA-modified HEMA-grafted cryogel column, loaded with Cu²⁺, was used for the capture of recombinant (His)₆-lactate dehydrogenase (LDH) from the crude homogenate of Escherichia coli and homogenate clarified by centrifugation. The cell homogenate with OD₆₂₀ 0.5 was applied to the column in 20 mM HEPES, with 200 mM NaCl and 2 mM imidazole, pH 7.0 as a running buffer until breakthrough (15%). Elution buffer was 20 mM EDTA, 50 mM NaCl, pH 8.0. The elution fractions were dialyzed against 20 mM Tris-HCl buffer, pH 7.0. The chromatography was monitored using LKB UVI-cord equipped with a 276 nm filter. The protein concentration was estimated using BCA method. The results are presented in Table 19.

TABLE 19
LDH-chromatography on IDA-modified HEMA-grafted
cryogels.

| | Capacity | | Protein | Dynamic binding |
|---|---|---|---|---|
| | for Cu⁺², | Cell homogenate | bound, | capacity for (His)₆- |
| G, % | μmol/ml | applied | mg/ml | LDH activity, U/ml |
| 34 | 58 | clarified | 0.3 | 2.3 |
| 130 | 55 | crude | 0.1 | 0.8 |

### EXAMPLE 9

### A. Production of Cryogel Beads

A solution of poly(vinyl alcohol) (PVA, MOWIOL 20-98, 100 g/L) was prepared. The PVA-cryogel beads were formed using cryogranulation set-up. The solution of PVA was pressed into liquid-jet-head where the jet was splinted into droplets by the flow of water immiscible solvent (petroleum ether). The droplets of the suspension fall down into the column filled with the same solvent cooled till −20° C. and froze to form spherical beads. Frozen beads were gathered in a collector at the bottom of the column. The beads were kept frozen at −20° C. overnight and then thawed at a rate 0.01° C./min. After washing the thawed beads with deionized water they were cross-linked with 0.5% glutaraldehyde (pH 1.0) under shaking on a rocking table for 1 hour. Finally the cross-linked f-cryoPVAG beads were washed with deionized water until washing waters were neutral.

### B. Graft Copolymerization of Acrylamide onto PVA-Cryogels and Hydrolysis of Graft Polyacrylamide to Polyacrylic Acid

Two grams of beads from section A above was suspended in 12 ml of distilled water. After acrylamide (AAm, 0.323 g) was added, the suspension was flushed with N₂ for 20 min. Then 0.5 ml of ceric ammonium nitrate (CAN) solution (0.1 M in 0.2 M HNO₃) was added to initiate the graft polymerization. The reaction was allowed to proceed overnight at room temperature on the rotating table. The beads with grafted poly(acrylamide) were treated with 0.1 M NaOH solution during overnight at room temperature and constant shaking for the hydrolysis of acrylamide groups to carboxyl groups. The assay for carboxyl content of graft PVA-cryogel beads was determined by acid-base titrometry. The beads were washed with excesses of distilled water until pH 7.0. One gram of beads was transferred to standard 0.1 M HCl solution containing 2 M NaCl (25 ml) in a beaker. The material was incubated for 24 h at room temperature and periodical agitation before an accurately measured sample of supernatant (10 ml) was removed and titrated with 0.1 M NaOH to pH 6.9-7.3 at slow stirring.

Batch experiments of lysozyme and Cu⁺² adsorption onto PVA-cryogels demonstrate that modified samples bind 3.7 mg of protein and 9.6 μmol of Cu⁺² per 0.1 g of dried polymer of beads (Table 20). Moreover the presence of plenty carboxyl groups leads to increasing of grafted PVA-cryogel swelling degree (Table 20), that is visually observed as an increase in bead size.

TABLE 20

| | Acid-base | Capacity | Capacity | |
|---|---|---|---|---|
| | titrometry, | for Lysozyme, | for Cu⁺², | Swelling |
| | μmol of | mg/0.1 g | μmol/0.1 g | degree (g |
| | NaOH/g of | of dried | of dried | water/g |
| | beads | polymer* | polymer* | dry polymer) |
| PVA-cryogel | 100 | 0.061 | 0 | 9.0 |
| beads | | | | |
| Grafted PVA- | 155 | 3.7 | 9.6 | 14.3 |
| cryogel beads | | | | |
| after treating | | | | |
| with 0.1 M | | | | |
| NaOH | | | | |
| PVA-cryogel | 100 | — | — | 10.0 |
| beads, | | | | |
| contained Ce⁺⁴ | | | | |

*0.1 g of dried polymer = 1 g of swelled not modified PVA-cryogel bead

### EXAMPLE 10

### Graft Polymerisation of Acrylic Acid onto PVA-Cryogel Beads Esterified with Acrylic Acid or Glycidyl Methacrylate

Three grams of PVA-cryogel beads prepared according to Example 9A was mixed with 4.5 ml of acrylic acid (AAc) in 30 ml of 0.5 M HCl solution, and the esterification reaction was carried out at room temperature for 96 h with continuous stirring on the shaker table.

Three grams of PVA-cryogel beads was mixed with 4.5 ml of AAc in 30 ml of 0.5 M HCl solution, and the esterification reaction was carried out at room temperature for 96 h with continuous stirring on the shaker table. Alternatively, 3 g of PVA-cryogel beads was mixed with 6 ml of allyl glycidyl ether in 30 ml of 1.0 M Na₂CO₃ solution, and the esterification reaction was carried out at room temperature for 96 h with continuous stirring on the shaker table.

Modified PVA-cryogel beads (1.5 g) were suspended in 13 ml of degassed distilled water. Then 2 ml of AAc was added. The graft polymerization was initiate by adding of 376 μmol TEMED and 300 mg APS. The reaction was allowed to proceed overnight at room temperature on the shaker. After the reaction was complete cryogel beads were washed with excess of water.

Grafted with polyacrylic acid PVA-cryogels were analyzed by sorption of Cu⁺² and lysozyme (Table 21).

TABLE 21

| | | Capacity | Capacity | |
|---|---|---|---|---|
| | | for lysozyme, | for Cu⁺², | Swelling |
| | | mg/0.1 g of | μmol/0.1 g | degree (g |
| | Reagent for | dried | of dried | water/g |
| | esterification | polymer* | polymer* | dry polymer) |
| Untreated | — | 0.061 | 0 | 9.0 |
| PVA- | | | | |
| cryogel | | | | |
| beads | | | | |
| PVA- | AGE | 27 | 530 | 105 |
| cryogel | AAc | 25 | 780 | 140 |
| beads | | | | |
| grafted | | | | |
| with AAc | | | | |

*0.1 g of dried polymer = 1 g of swelled not modified PVA-cryogel beads

The profile of Cu⁺² elution with 0.1 M EDTA solution pH 7.5 was investigated. During applying 0.2 M CuSO₄ solution to the column AAc-grafted PVA-beads shrank and their volume decreased in twice. As carboxyl groups interact with Cu⁺² ions and the hydration of polyacrylic acid decrease at that condition. After elution with 0.1 M EDTA swelling degree of cryogel matrix increased again.

The break-through profile of lysozyme on a column packed with polyacrylic acid grafted PVA beads was investigated. The break-through curve demonstrates unstable chromatographic behaviour during the application of lysozyme solution. Adsorption of lysozyme to the column resulted in developing backpressure and decreasing flow rate through the column at the same pumping speed. The same problem was observed when the elution with 1.5 M NaCl solution was performed. During the experiment flow rate through the column decreased from 1 to 0.3 ml per min.

The capacity of retained lysozyme at 40% break-through was 50 mg per ml of gPVA-AAc. Mostly the protein was adsorbed on the polyacrylic acid chains grafted on the surface of cryogel beads and eluted in first fraction.

### EXAMPLE 11

### Graft Polymerization of Acrylic Acid onto PVA-Cryogel Monolith

Fifty ml of 0.5 M HCl solution were passed through the PVA-cryogel monolith (2 ml; produced according to PCT/SE02/01857) at a flow rate of 1 ml/min followed by 30 ml of 2.0 M AAc solution in 0.5 M HCl was applied to the column at a flow rate 1 ml/min in recycle mode overnight at room temperature. Then the modified cryogel in the column was washed with water until pH was neutral. Then 2.0 M AAc solution was applied at a flow rate 0.2 ml/min. Every 40 min activator and initiator (50 μL of TEMED and 50 mg of APS) were injected. Reaction proceeded for 5 h at room temperature.

The grafted PVA-cryogel monolith adsorbed 40 μmol of Cu⁺² per ml of cryogel.

The profiles of breakthrough and elution for lysozyme on the gPVA-AAc monolith was investigated. The capacity for lysozyme was 15 mg per ml of gPVA-AAc. The creating of backpressure and decreasing of flow rate through the column that was typical for beads was not observed in this case.

### EXAMPLE 12

### Graft Copolymerization of NIPSM and 3-(acrylamido)phenylboronic Acid) (APBA)

Plain cryogel monoliths were prepared using 6% solution of co-monomers (AAm/MBAAM=8/1). A dried pAAm cryogel (0.09-0.14 g) was placed in a glass tube and saturated with 10 ml of reaction solution containing appropriate amounts of NIPAM and APBA (NIPA/APBA=9/1 (mole/mole)), 0.06 ml NaOH (10 M) and 3 ml of Cu(III) solution (prepared as in Example 3). The flow of monomer through the cryogel was stopped with a cork. The graft polymerization proceeded for 20 h at room temperature.

After completion of the reaction, the cryogels were washed with 30 ml 0.1 M HCl followed by washing with an excess of deionized water.

The grafting percentage, G % was calculated as in Example 3. The results are presented in Table 22.

TABLE 22
Graft copolymerization of NIPAM and APBA.

| Concentration of NIPA, mg | G % |
|---|---|
| 0.2 | 3 |
| 0.4 | 12 |
| 0.7 | 30 |

1. Macroporous cryogel having grafted thereon polymer chains formed by polymerizing at least one monomer of the general formula (I)
CR₁R₂═CR₃R₄ (I)
wherein R₁ and R₂ are equal or different and each represents a hydrogen atom or a substituent group which is not detrimental to the polymerization reaction; and
R₃ and R₄ each represents a hydrogen atom or a substituent group which is not detrimental to the polymerization reaction, provided that R₃ and R₄ are not both a hydrogen atom, on said macroporous cryogel.

2. Macroporous cryogel according to claim 1, wherein R₁ and R₂ are both a hydrogen atom or one of R₁ and R₂ represents a hydrogen atom and the other represents a substituent selected from the group consisting of alcohols, organic acids, ethers, esters amides and N-substituted amides thereof, amines, N-substituted amines, heterocyclic aromatic rings and derivatives thereof.

3. Macroporous cryogel according to claim 1 or claim 2, wherein one of R₃ and R₄ represents a hydrogen atom or an alkyl group and the other is a member selected from the group consisting of a carboxyl group and derivatives such as alcohols, organic acids, ethers, esters, amides and N-substituted amides thereof, amines, N-substituted amines, heterocyclic aromatic rings etc.

4. Macroporous cryogel according to claim 3, wherein said derivative of a carboxyl group is one containing an affinity ligand bound thereto.

5. Macroporous cryogel according to claim 1, wherein said at least one monomer of the general formula (I) is at least one member selected from the group consisting of acrylic acid (AAc), methacrylic acid (MAc), N,N-dimethyl-aminoethylmethacrylate (DMAEMA), (2-(methacryloyloxy)ethyl)-trimethyl ammonium chloride (META), N-isopropylacrylamide (NIPAM), N-vinyl imidazole (VI), glycidylmethacrylate (GMA), hydroxyethyl methacrylate (HEMA), acrylamide, methylene-bis-acrylamide (MBAA) diallyltartaramide (DATAm), diallylacryalamide (DAAm), polyethyleneglycol di(meth)acrylate (PEGD(M)A), polypropylene glycol diglycidyl ether (PEG-DGE), 3-(acrylamido)phenylboronic acid (APBA) and derivatives thereof.

6. Macroporous cryogel according to any of claims 1 to 5, wherein the macroporous cryogel is a cryogel prepared by copolymerizing monomers selected from the group consisting of acrylic acid and derivatives thereof, one of said monomers being an acrylamide.

7. Macroporous cryogel according to claim 6, wherein the macroporous cryogel is a cryogel prepared by radical copolymerization of acrylamide and N,N′-methylene-bis-acrylamide.

8. Macroporous gel according to claim 1, wherein the macroporous cryogel is a poly(vinyl alcohol) cryogel cross-linked by means of a bifunctional reagent e.g. glutaraldehyde and said at least one monomer of the general formula (I) is a member selected from the group consisting of alcohols, organic acids, ethers, esters amides and N-substituted amides thereof, amines, N-substituted amines, heterocyclic aromatic compounds, all containing a polymerizable double bond.

9. Macroporous cryogel according to any of claims 1-8, which is in the shape of a monolith.

10. Method for graft (co)polymerization of at least one monomer of the general formula (I)
CR₁R₂═CR₃R₄ (I)
wherein R₁ and R₂ are equal or different and each represents a hydrogen atom or a substituent group which is not detrimental to the polymerization reaction; and
R₃ and R₄ each represents a hydrogen atom or a substituent group which is not detrimental to the polymerization reaction, provided that R₃ and R₄ are not both a hydrogen atom;
on a macroporous cryogel, which method comprises reacting said at least one monomer of the general formula (I) as defined above with a macroporous polyacrylamide cryogel in the presence of potassium diperiodatocuprate as an initiator.

11. Method according to claim 10, wherein dry macroporous polyacrylamide cryogel is brought in contact with an alkaline aqueous solution of said at least one monomer of the general formula (I) and potassium disperiodatocuprate.

12. Method according to claim 10, wherein dry macroporous polyacrylamide cryogel is saturated with an alkaline aqueous solution of potassium disperiodatocuprate in a column, where after said alkaline aqueous solution is displaced from the cryogel by passing an aqueous or aqueous-organic solution of said at least one monomer of the general formula (I) therethrough whereafter graft (co)polymerization is allowed to proceed.

13. Method according any of claims 10 to 12, wherein the macroporous cryogel thus prepared, having polymer chains grafted thereon, is further reacted with a reagent introducing an affinity ligand thereon.

14. Method for graft polymerization of a monomer selected from the group consisting of acrylamide and acrylic acid on a macroporous cryogel, which method comprises reacting said monomer with a macroporous poly(vinyl alcohol) cryogel in the presence of at least one member selected from the group consisting of initiators and activators for the polymerization reaction.

15. The use of a macroporous cryogel as defined in any of claims 1 to 9 in a separation process.

16. Use according to claim 15, wherein said macroporous cryogel is a macroporous polyacrylamide cryogel carrying tertiary and quarternary amino groups prepared by graft polymerization of a monomer selected from the group consisting of N,N-dimethylaminoethyl methacrylate (DMAEMA) and (2-(methacryloyloxy)ethyl)-trimethyl ammonium chloride onto the surface of said polyacrylamide cryogel, and wherein said macroporous cryogel is used for chromatography of RNA and gDNA.
